(19) United States
(12) Patent Application Publication
(10) Pub. No.: US 2015/0136186 A1
(43) Pub. Date: May 21, 2015

(54) SYSTEM FOR PROCESSING SUBSTRATES WITH TWO OR MORE ULTRAVIOLET LIGHT SOURCES THAT PROVIDE DIFFERENT WAVELENGTHS OF LIGHT

(71) Applicant: Tokyo Electron Limited, Tokyo (JP)

(72) Inventor: Ian J. Brown, Austin, TX (US)

(21) Appl. No.: 14/546,804

(22) Filed: Nov. 18, 2014

Related U.S. Application Data
(60) Provisional application No. 61/906,784, filed on Nov. 20, 2013.

(51) Int. Cl. B08B 7/00; B08B 3/10; B08B 3/08

(52) U.S. Cl. CPC B08B 7/0057; B08B 3/08; B08B 3/10
USPC 134/113

(57) ABSTRACT

Systems for cleaning substrates including cleaning of semiconductor substrates, use atmospheric or sub-atmospheric ultraviolet (UV) light to improve selectivity of conventional wet chemical cleaning in the manufacture of semiconductor devices. The UV light systems are configured to improve front-end-of-line (FEOL) (e.g., non-metal) or back-end-of-line (BEOL) (e.g., metal) removal of etch by-products (e.g., polymers) and/or mask layers from underlying materials. Systems herein can be configured with multiple lamps that irradiate substrates, gasses, and liquids at different bandwidths. Selectivity and queue time is improved while reducing processing temperatures.

### CROSS REFERENCE TO RELATED APPLICATIONS

The present application claims the benefit of U.S. Provisional Patent Application No. 61/906,784, filed on Nov. 20, 2103, entitled “System for Processing Substrates with Two or More Ultraviolet Light Sources that Provide Different Wavelengths of Light,” which is incorporated herein by reference in its entirety.

### BACKGROUND OF THE INVENTION

The present application generally relates to semiconductor processing and specifically to a substrate cleaning process.

Patterning and selectively etching of materials may be used to form structures that enable the control or manipulation electrical signals in electrical devices. The etching of patterns into the materials may result in a by-product (e.g., polymer) that may adhere to or form on the surface of a recently etched surface area. Unfortunately, the by-product may interfere with the control or manipulation of electrical signals of a completed electrical device. A process that may remove the polymer without damaging or altering the underlying material may be desirable.

Selective etching may also be enabled by applying mask layers over the underlying material. However, the mask layer may need to be removed to complete a functional electrical device. The mask layer may be removed using a separate process from the by-product removal process or the mask layer and the by-product may be removed in the same or substantially similar process.

### SUMMARY

Systems and techniques described herein relate to removing, cleaning, or etching of etch by-products (e.g., polymers) or mask layers used in semiconductor processing of substrates. Ideally, removal of by-products or mask layers is accomplished without damaging or altering the underlying materials and structures. One way to characterize or quantify damage or alterations in the underlying materials is process selectivity. Process selectivity includes referring to how much impact a given by-product removal process has on the underlying material. Having lower process selectivity can result in a removal process damaging or altering underlying materials to a greater degree as compared to a process with higher or greater selectivity. For example, a given by-product removal process with low selectively can alter a dielectric constant of underlying material and/or thickness or structure of the underlying material to a greater degree as compared to a process with higher selectivity. For some fabrication techniques it is preferable to use a by-product removal process that minimizes impact (e.g., higher selectivity) on underlying materials and structures.

In one embodiment, selectivity of a by-product and/or mask layer removal process can be improved by exposing a corresponding substrate to two or more bandwidths of ultraviolet light causing improved selectivity. For example, a wet chemical process tool can include a light module that enables such exposure before, after, or during the application of the wet chemicals. This light module can include two or more ultraviolet sources that generate different wavelengths of light. The substrate may be moved underneath the ultraviolet sources in a linear manner, in a rotating manner, or in a combination thereof.

In one embodiment, the ultraviolet sources may be linear and have a length that is greater than the width. The two or more ultraviolet sources may be placed adjacent to each other such that two or more wavelengths of light may intercept the surface of the substrate at a same time or approximately similar time. In other embodiments, however, the ultraviolet sources may be separated by a distance that minimizes the amount of surface area of the substrate that may be intercepted by light from the two or more of the ultraviolet sources. In another embodiment, the ultraviolet sources may be substantially radial or have lengths and widths that are substantially similar.

Of course, the order of discussion of the different steps as described herein has been presented for clarity sake. In general, these steps can be performed in any suitable order. Additionally, although each of the different features, techniques, configurations, etc. herein may be discussed in different places of this disclosure, it is intended that each of the concepts can be executed independently of each other or in combination with each other. Accordingly, the present invention can be embodied and viewed in many different ways.

Note that this summary section does not specify every embodiment and/or incrementally novel aspect of the present disclosure or claimed invention. Instead, this summary only provides a preliminary discussion of different embodiments and corresponding points of novelty over conventional techniques. For additional details and/or possible perspectives of the invention and embodiments, the reader is directed to the Detailed Description section and corresponding figures of the present disclosure as further discussed below.

### BRIEF DESCRIPTION OF THE DRAWINGS

A more complete appreciation of various embodiments of the invention and many of the attendant advantages thereof will become readily apparent with reference to the following detailed description considered in conjunction with the accompanying drawings. The drawings are not necessarily to scale, with emphasis instead being placed upon illustrating the features, principles and concepts.

FIG. 1 is a cross-sectional schematic view of a cleaning system according to embodiments herein.

FIG. 2 is a cross-sectional illustration of a substrate segment having a hardmask on patterned features according to embodiments herein.

FIG. 3 is a cross-sectional illustration of a substrate segment having a hardmask and polymer coating on patterned features according to embodiments herein.

FIG. 4 is a cross-sectional schematic top view of a cleaning system according to embodiments herein.

FIG. 5 is a cross-sectional schematic side view of a cleaning system according to embodiments herein.

FIG. 6 is a cross-sectional schematic top view of a cleaning system according to embodiments herein.

FIG. 7 is a cross-sectional schematic top view of a cleaning system according to embodiments herein.

FIG. 8 is a schematic top view of a cleaning system according to embodiments herein.

FIG. 9 is a graph showing wavelength emission bands of various light systems.

FIG. 10 is a graph illustrating light absorbance of various materials.

### DETAILED DESCRIPTION

Techniques herein include systems using atmospheric or sub-atmospheric ultraviolet (UV) light to improve selectivity (e.g., performance) of conventional wet chemicals in the manufacture of semiconductor devices including cleaning of semiconductor substrates. The UV light systems can be used to improve front end of line (FEOL) (e.g., non-metal) or back end of line (BEOL) (e.g., metal) removal of etch by-products (e.g., polymers) and/or mask layers from underlying materials. It is common for semiconductor devices to be fabricated by successive deposition, patterning, and etching of materials on a substrate. Various etching processes can remove selective portions of an underlying material, but may generate a by-product that adheres to or forms on the etched surface area of the underlying material. Such by-products can interfere with the electrical performance of the semiconductor device it is typically desired to remove these byproducts and/or masks. Selective etching of underlying material may be enabled by a patterned mask layer. Mask layers the typically need to be removed to enable proper operation of electrical devices being fabricated. The UV exposure system and process herein may also be used to improve selectivity of the mask removal process.

Electromagnetic radiation sources and/or UV light sources are commonly used in semiconductor manufacturing, such as for creating latent patterns in photoresist and annealing materials. Various conventional UV light sources can be selected for use with systems herein. Selection of a particular UV source can be based on wavelength of light desired, intensity and mode of delivery (for example, whole wafer radiation or linear scan). Examples of UV light sources that can be selected include mercury (Hg) lamps or Amalgam (Hg/Ag/Sn/Cu) lamps. These can be any of low-pressure, medium-pressure, or high-pressure. The emission spectra from a typical low-pressure Amalgam lamp can have a primary peak at approximately 240-260 nanometers (nm) with essentially little or no peaks outside of this range. Lamps can include ozone-free and ozone-generating units depending on a selection of class used for the bulb. Medium-pressure lamps can have multiple wavelength peaks between 200-600 nm.

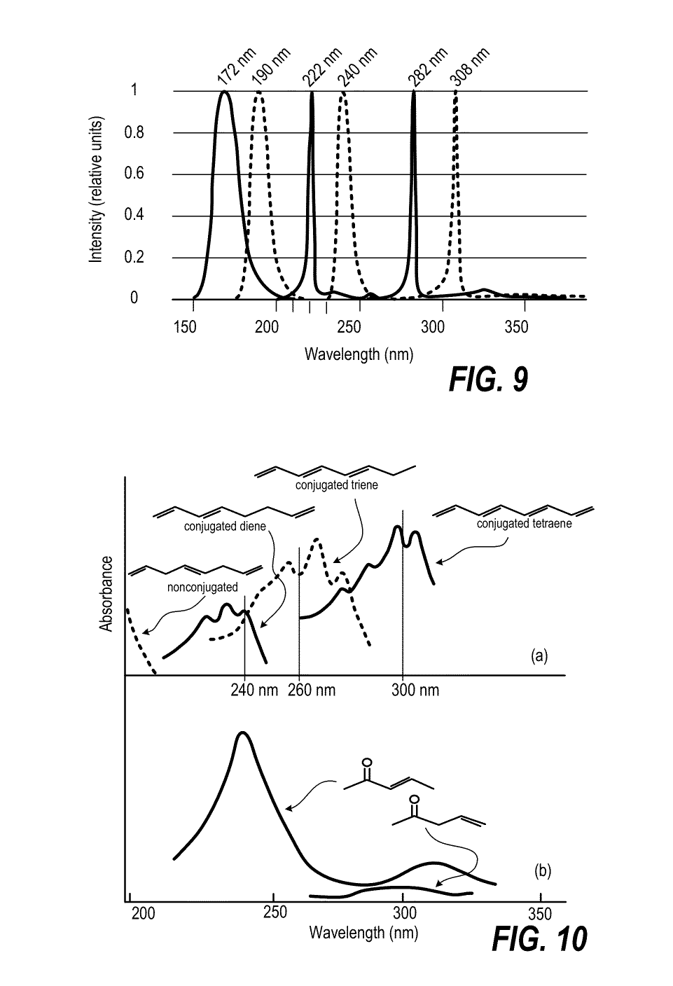

In other embodiments, systems herein use two or more excimer lamps. Excimer lamps can provide a light source having a relatively narrow bandwidth. Excimer lamps can be selected to provide particular UV wavelengths including: 172 nm, 190 nm, 222 nm, 248 nm, 282 nm, 308 nm. FIG. 9 is an illustration of a graph showing wavelength emission bands of various blue light excimer systems. For lasers, either the light source would have to be scanned across the substrate or a beam expander would be used to increase exposure area on the wafer surface or a multitude of expanded beams. Laser options include output options of 157 nm, 193 nm (ARF), 248 nm, 308 nm, 351 nm, 9.4 um-10.8 um (CO2 laser). Arc and Flash lamps (continuous wave or pulsed) can include Xenon and Krypton. Vacuum UV Lamps can be used such as deuterium lamps that provide between 115 nm and 400 nm depending on a window. Using a light source that emits at essentially a single wavelength can be beneficial in terms of thermal budget. For example, broad spectrum light can undesirable heat a substrate, especially with infrared light. Moreover, filtering broad spectrum light—so that a substrate is exposed only with particular UV wavelengths—is problematic and inefficient. As described herein, using two or more light sources having a narrow band can increase cleaning efficacy, while maintaining a low thermal budget and avoiding undesirable heating of a given substrate.

In one embodiment, a selected UV light wavelength may vary from a target frequency or wavelength of the UV light source. The variation in wavelength may be characterized by the full width at half maximum (FWHM) which indicates the wavelength range in which the power of the UV light is attenuated from its peak value. For example, a 193 nm UV source may include a variation of up to 14 nm under the FWHM guidelines. The FWHM for the 222 nm light source and the 254 nm light source may be 3 nm.

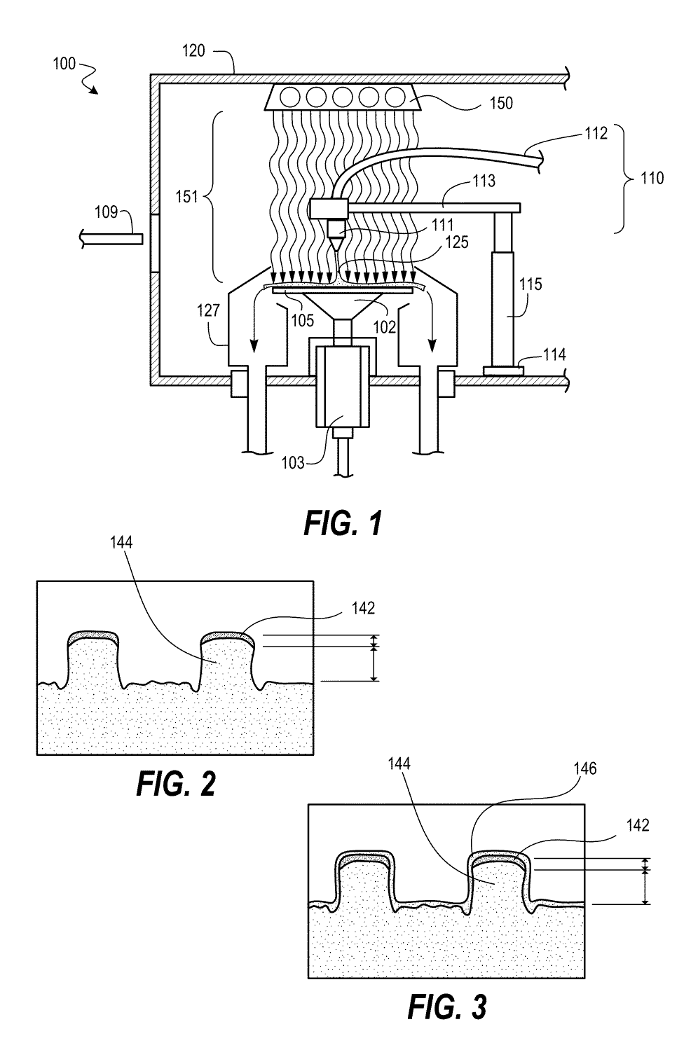

Referring now to FIG. 1, a cross-sectional schematic view illustrates an embodiment of an example cleaning system 100 (wet clean system) for cleaning a substrate 105. The substrate 105 can include semiconductors, flat panels, wafers, etc. The cleaning system 100 includes a wet clean system 110, a process chamber 120, and a fluid delivery subsystem. The wet clean system 110 can include a nozzle 111 for dispensing liquid chemistry onto a surface of substrate 105. The nozzle 111 can be connected to a fluid delivery subsystem via feed pipe 112. A nozzle arm 113 can be mounted on a vertical support member 115 that can be horizontally moveable on a guide rail 114, or rotationally movable. The substrate 105 can be received in the cleaning system 100 via delivery member 109, which can place substrate 105 on substrate holder 102. Substrate holder 102 can include drive motor 103 configure to rotate substrate holder 102 at a given rotational velocity. The cleaning system can include UV light source 150 configured to irradiate UV light towards substrate 105. UV light source 150 can be part of a light module within the process chamber 120, or a separate light module with a respective substrate holder/movement system can be used. A system controller (not shown) can be coupled to the substrate cleaning system and configured to control rotation speed of the substrate, UV irradiation, and treatment liquid delivery.

The substrate 105 can include a hardmask layer 142 deposited on an underlying layer 144 as illustrated in FIG. 2. FIG. 2 is a cross-sectional illustration of an example substrate segment. Note that the hardmask layer 142 can be used to transfer a mask pattern into the underlying layer 144. Example substrates can have ultra low-k features with a TiN hardmask—or other hardmask layer 142—on top of the low-k features. The hardmask layer 142 can be a layer or film that has a greater density as compared to the low-k material. This hardmask layer 142 can be used to improve etching processes into softer low-k dielectrics. In example embodiments, a hardmask layer composition can be comprised of a material SixM(1-x)NyOzBw, wherein M represents either individually or a combination of Ti, W, Ta, Ge, C and x is less than 1 including zero. A given hardmask film can be in a crystalline or amorphous state. The hardmask can include a metal hardmask layer using one or more of titanium nitride (TiN), tantalum nitride (TaN), silicon carbide (SiC), and amorphous carbon. Etching of substrate 105 can result in a polymer coating 146, as shown in FIG. 3, which typically needs to be removed from substrate 105 for subsequent fabrication. Such polymer coatings can be exceedingly difficult to remove, but systems herein, including irradiation using UV light, change material properties to enable effective cleaning of such polymer films. It is common to need tight queue times (minutes to hours) from etch to wet clean, otherwise certain polymer films do not respond to wet cleaning methods. The cleaning system herein, however, enables effective removal of such films even after relatively long periods between etching and cleaning (days to weeks).

Cleaning system 100 is configured to spin the substrate 105 in the process chamber 120 and deposit a cleaning solution (such as a hydrogen peroxide solution 125) on a top surface of the substrate 105. Cleaning system 100 is configured to irradiate substrate 105 prior to a wet clean or during a wet clean while chemicals are being dispensed. UV irradiation of polymer material, as discovered herein, prior to wet cleaning and/or during wet chemistry dispensing can facilitate cleaning of polymer and/or metal layers using wet chemistry solutions. More details related to example processes that can be executed using systems herein can be found in U.S. patent application Ser. No. 14/537,652 filed on Nov. 10, 2014 entitled “System and Method for Enhanced Removal of Metal Hardmask Using Ultra Violet Treatment,” and Ser. No. 14/537,702 filed on Nov. 10, 2014 entitled “Method and Hardware for Enhanced Removal of Post Etch Polymer and Hardmask Removal,” which are both incorporated by reference in their entirety.

Embodiments of a UV light module can include two or more UV light sources, and can be arranged to expose substrates to two or more bandwidths of UV light. In one instance, the power or intensity of each of the light sources may vary individually or in combination during the exposure process.

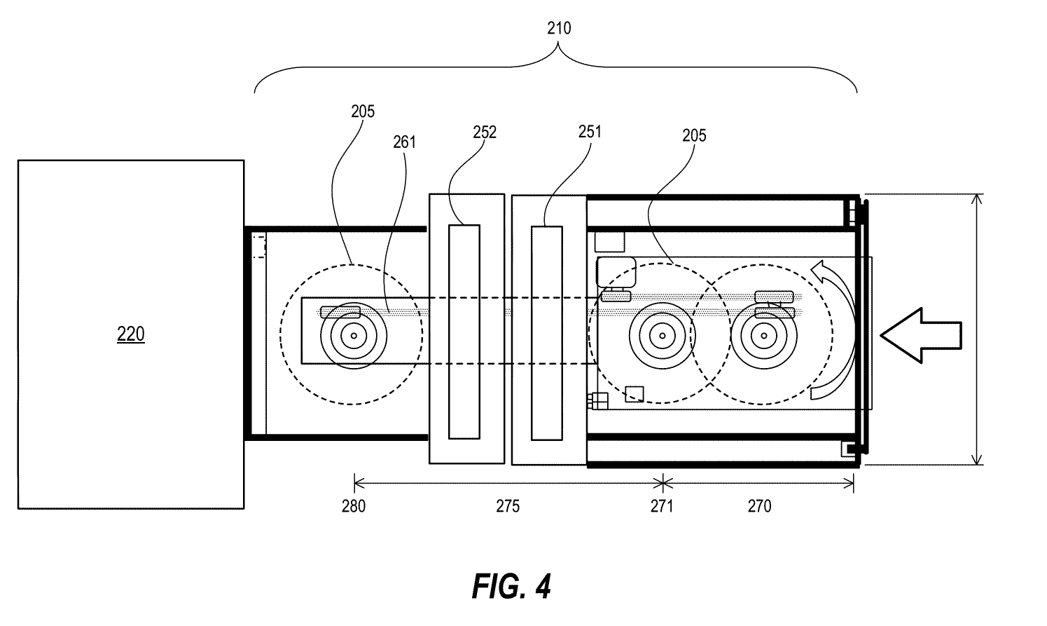

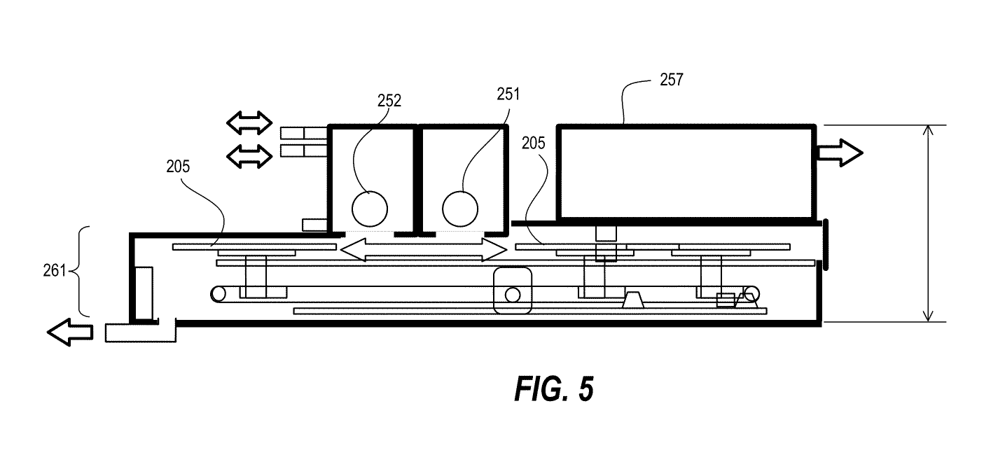

FIGS. 4 and 5 illustrate an alternative example embodiment of a substrate cleaning system. FIG. 4 shows a top schematic view, while FIG. 5 shows a side schematic view. This system includes wet clean module 220, which is configured to apply wet chemicals to a semiconductor substrate. Also included is light module 210, configured to apply ultraviolet light to a substrate 205. The light module 210 can include a first ultraviolet light source that provides light at a first wavelength when the first ultraviolet light source is activated. The light module 210 can also include a second ultraviolet light source that provides light at a second wavelength when the second ultraviolet light source is activated. The second wavelength is greater than the first wavelength. In some embodiments, the first and second light sources can be selected as excimer lamps. A substrate transfer mechanism 261 is configured to transfer the substrate 205 between the wet clean module 220 and the light module 210, and within the light module 210.

The light sources 251, 252 can be positioned adjacent to each other and the substrate 205 may be moved linearly underneath the UV light sources. Power source 257 can be used to power UV light sources. The UV light source may include a length that is substantially larger than the width. Hence, the light may be focused along the length of the UV light source and the substrate can be moved through that length to uniformly expose the substrate to UV light. In other embodiments, the substrate 205 can be aligned under the UV light source and can be rotated to expose most of the substrate directly to the light provided from the UV light source. In other embodiments, the substrate can remain stationary while a light source is moved over or across the substrate.

A particular UV light exposure process implemented with the cleaning system herein can vary on exposure time, scan speed, UV light intensity and/or power, exposure distance, and/or substrate rotation speed. These process parameters can be controlled by a computer processor (not shown) that executes computer-readable instructions that control the hardware related to these process parameters. A specific exposure time selected can be the amount of time that a substrate may be exposed directly or indirectly to the UV light source(s). Exposure time selection can also be based upon the scan speed of the substrate transfer mechanism. Scan speed and exposure time can be controlled to optimize UV light exposure uniformity across the substrate. The exposure distance may also be varied by the substrate transfer mechanism or by moving the UV light sources. The exposure distance can be a distance between the UV light source(s) and the substrate or the surface of the substrate. The exposure distance may be up to 10 centimeters or more, and can be as close as a centimeter. The substrate transfer mechanism 261 can also rotate the substrate when exposed to the UV light sources. The rotation speed may be up to 1000 revolutions per minute (rpm), which can help enable exposure uniformity.

Embodiments of UV light modules can have a various specifications. For example, light output wavelengths can range from 185 nm to 600 nm. In one specific embodiment, the wavelengths may include, but are not limited to, one or more of the following 172 nm, 190 nm, 222 nm, 230 nm, 248 nm, 250 nm, 282 nm, and/or 308 nm. In one embodiment, the first wavelength comprises a wavelength between 185 nanometers and 240 nanometers, while the second wavelength comprises a wavelength between 240 nanometers and 270 nanometers. In other embodiments, the second wavelength comprises a wavelength that is greater than 270 nanometers. Note that more light sources can be added. For example, a third (or forth, etc.) ultraviolet light source can provides light at a third wavelength when the third ultraviolet light source is activated. The third wavelength being greater than the second wavelength. The first wavelength and the second wavelength can comprise a wavelength that is less than 240 nanometers, while the third wavelength comprises a wavelength that is greater than 240 nm. In other embodiments, the first wavelength comprises a wavelength between 185 nanometers and 195 nanometers, and wherein the second wavelength comprises a wavelength that is greater than the first wavelength and that is less than the third wavelength. In some embodiments, the first wavelength comprises a wavelength of 190 nanometers, the second wavelength comprises a wavelength of 230 nanometers, and the third wavelength comprises a wavelength of 250 nanometers.

The UV light module may also include a light intensity controller or UV power source that may control the power to each of the UV light sources individually or collectively. The power or intensity of the UV light source may vary depending upon the wavelength of the UV light source and the type of materials on the substrate. Materials may respond differently to different wavelengths of UV light and their corresponding intensity. In some instances, one or more UV light sources may not be used or used at a lower intensity than the remaining UV light sources. For example, certain dielectric materials are more likely to alter their dielectric constant when exposed to specific wavelengths of UV light. Hence, it may be advantageous to avoid using that wavelength. In one instance, a given specific UV light source may not be turned on when processing a substrate, but the remaining UV light sources may be turned on during processing. In another instance, the impact of a wavelength of light above a certain power or intensity may impact the dielectric constant of the substrate materials. Accordingly, the substrate may be exposed to that particular UV light wavelength, but the power intensity of that wavelength may be lower relative to the intensity of other UV light wavelength sources.

In one specific embodiment, power levels for UV light sources with a wavelength less than or equal to 200 nm can be lower than power levels for UV light sources with a wavelength greater than 200 nm. In other embodiments, however, the UV light module may vary the power levels to the UV light sources regardless of wavelength. Power levels can also be ramped up or ramped down from a set point during substrate processing. For example, an initial power set point may be lower or higher than an ending power set point for the process. In certain instances, the ramping of the power levels may be independent of each other or they may be ramped in unison.

FIG. 10 is a graph that illustrates how material characteristics can change with wavelength. In this example, light absorbance of four materials varies between 200 nm and 350 nm. Accordingly, power levels to each individual UV light source may be varied to account for these differences in absorbance. In other embodiments, however, material characteristics may vary outside this example illustrated range and thus power levels can be adjusted accordingly. Also, other material characteristics may vary with wavelength. Example characteristics can include, but are not limited to, conductance, dielectric constant, resistivity, density, and bond energies.

A UV light module herein can include a process chamber that can operate at atmospheric or sub-atmospheric conditions. In one embodiment, the UV light module can operate at or above atmospheric pressure using one or more of the following fluids: dilute hydrogen peroxide solution, deionized water, dilute hydrogen fluoride solution, proprietary semi-aqueous solvent mixture, dilute carbonic acid and/or dilute ammonium hydroxide mixture. In one specific non-limiting embodiment, the UV light module can use air (N2/O2 mixture) for atmospheric or higher processing. In another embodiment, the UV light module may operate at sub-atmospheric pressures using a vacuum pump or other exhaust means conventionally known. The gases may be used to control an amount of ozone or monatomic oxygen that is provided to the substrate. A particular concentration of these gases may also be optimized based, at least in part, on the wavelengths of the UV light sources. For example, relatively higher oxygen or ozone gas flows can be used when selected UV light sources provide light with wavelengths less than 240 nm.

In other embodiments, the UV light module can include a gas distribution system, a vacuum system, and a temperature control system. The gas distribution system can be configured to flow one or more of the following gases: air (N2/O2 mixture), ozone, nitrogen, argon, and ammonia. In some embodiments, a gas distribution controller that can be configured to apply a higher flow rate of ozone to the first ultraviolet light source as compared to the second ultraviolet light source.

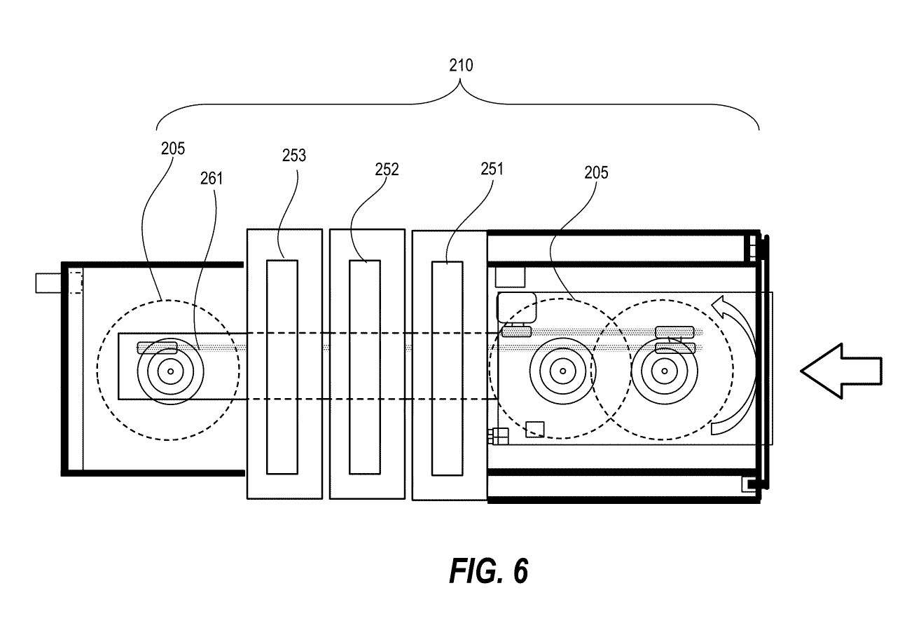

Cleaning systems herein can have various configurations. For example, FIG. 6 illustrates one embodiment of light module 210 that includes three light sources (251, 252, 253) that can provide UV light at several wavelengths. Light provided by these light sources can be a narrow band, which is beneficial to keep thermal heating to a minimum while enabling effective polymer and metal removal. The UV power controller may vary the power and/or duration of the power to each of the individual light sources. The light module in FIG. 6 can operate in a similar manner as the embodiments described in FIGS. 4-5.

In other embodiments, UV light modules can have UV light sources positioned so that a substrate passes along the length of the light source, that is, in a lengthwise path as an alternative to a crosswise path under a UV light source. In this embodiment—or other embodiments—the substrate can be optionally rotated so that different wavelengths of light can be more uniformly applied to a substrate.

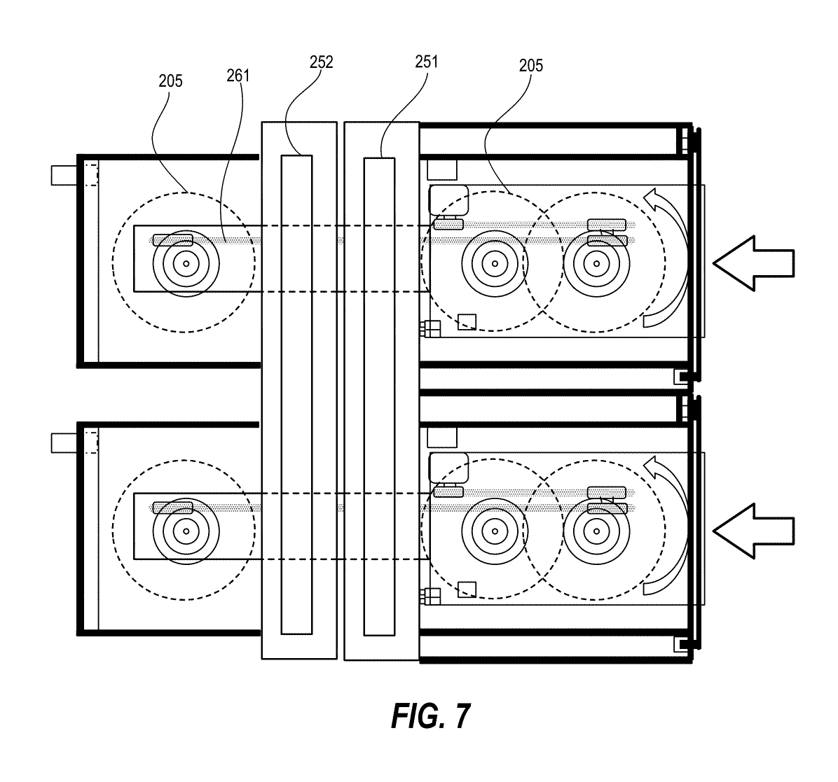

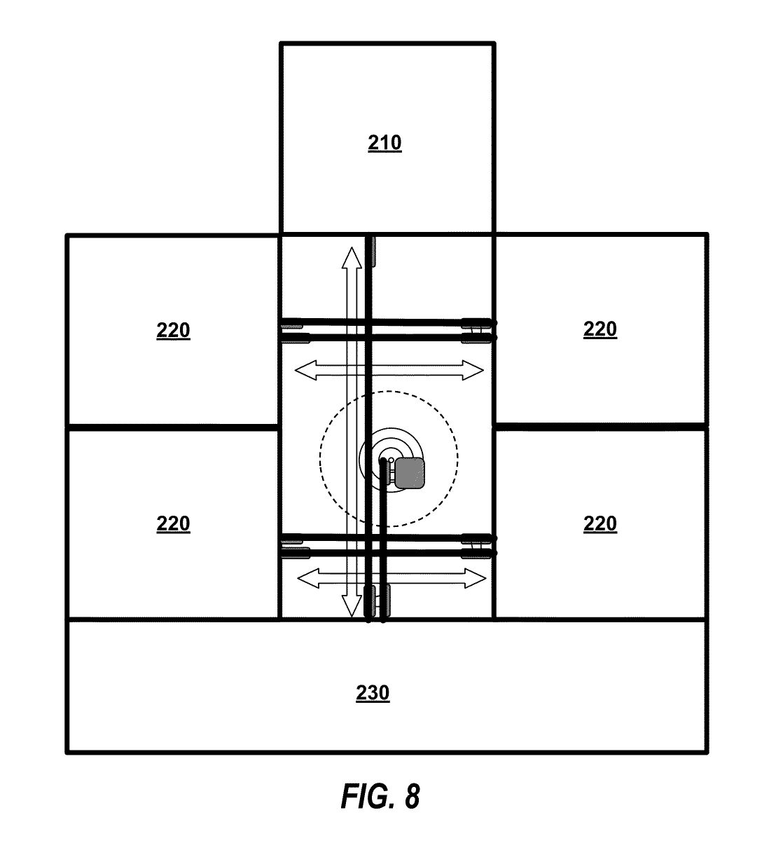

Other embodiments can include configurations in which light sources 251 and 252 span multiple light modules. FIG. 7 is a schematic illustration of such example light sources that span multiple modules so that each light module essentially shares a particular light source. Note that as illustrated, two substrates can pass underneath light sources 251 and 252. It should be understood that various embodiments herein can use two or more light sources for any given light module, and that a given light source can be used for one or more modules. FIG. 8 is a schematic illustration of an example multi-chamber embodiment such as a semiconductor manufacturing tool. This embodiment includes substrate loading module 230 which can receive substrates to be cleaned, such as substrates recently being etched. The tool can then transport substrates to light module 210 for irradiation with UV light to condition particular substrate materials for easier or more effective wet cleaning. A UV light-exposed substrate can then be transferred to any of wet clean 220. Note that in this embodiment, light module 210 is a separate module from wet clean module 220. In other embodiments, UV light sources can be combined with wet clean modules, such as shown in FIG. 1.

The light module 210 can process substrates before or after the substrate is processed in the wet clean process chamber. In other embodiments, substrates can be processed by the UV light module before and after processing in the wet clean process chamber. Similarly, the UV light module may process substrates between wet clean steps performed in wet clean module 220. In another embodiment, the light module 210 attached to a wet clean process chamber may include three or more different UV light sources as described above.

In the preceding description, specific details have been set forth, such as a particular geometry of a processing system and descriptions of various components and processes used therein. It should be understood, however, that techniques herein may be practiced in other embodiments that depart from these specific details, and that such details are for purposes of explanation and not limitation. Embodiments disclosed herein have been described with reference to the accompanying drawings. Similarly, for purposes of explanation, specific numbers, materials, and configurations have been set forth in order to provide a thorough understanding. Nevertheless, embodiments may be practiced without such specific details. Components having substantially the same functional constructions are denoted by like reference characters, and thus any redundant descriptions may be omitted.

Various techniques have been described as multiple discrete operations to assist in understanding the various embodiments. The order of description should not be construed as to imply that these operations are necessarily order dependent. Indeed, these operations need not be performed in the order of presentation. Operations described may be performed in a different order than the described embodiment. Various additional operations may be performed and/or described operations may be omitted in additional embodiments.

“Substrate” or “target substrate” as used herein generically refers to an object being processed in accordance with the invention. The substrate may include any material portion or structure of a device, particularly a semiconductor or other electronics device, and may, for example, be a base substrate structure, such as a semiconductor wafer, reticle, or a layer on or overlying a base substrate structure such as a thin film. Thus, substrate is not limited to any particular base structure, underlying layer or overlying layer, patterned or un-patterned, but rather, is contemplated to include any such layer or base structure, and any combination of layers and/or base structures. The description may reference particular types of substrates, but this is for illustrative purposes only.

Those skilled in the art will also understand that there can be many variations made to the operations of the techniques explained above while still achieving the same objectives of the invention. Such variations are intended to be covered by the scope of this disclosure. As such, the foregoing descriptions of embodiments of the invention are not intended to be limiting. Rather, any limitations to embodiments of the invention are presented in the following claims.

1. A semiconductor substrate cleaning system comprising:
a wet processing module configured to apply wet chemicals to a semiconductor substrate; and
a light module configured to apply ultraviolet light to the semiconductor substrate, the light module comprising:
a first ultraviolet light source that provides light at a first wavelength when the first ultraviolet light source is activated;
a second ultraviolet light source that provides light at a second wavelength when the second ultraviolet light source is activated, the second wavelength being greater than the first wavelength; and
a substrate transfer mechanism configured to transfer the semiconductor substrate between the wet processing module and the light module.

2. The system of claim 1, wherein the first wavelength comprises a wavelength between 185 nanometers and 240 nanometers.

3. The system of claim 2, wherein the second wavelength comprises a wavelength between 240 nanometers and 270 nanometers.

4. The system of claim 2, wherein the second wavelength comprises a wavelength that is greater than 270 nanometers.

5. The system of claim 1, wherein the light module comprises:
a gas distribution system;
a vacuum system; and
a temperature control system.

6. The system of claim 5, wherein the gas distribution system comprises one or more of the following gases: air (N2/O2 mixture), ozone, nitrogen, argon, or ammonia.

7. The system of claim 6, further comprising a gas distribution controller that can be configured to apply a higher flow rate of ozone to the first ultraviolet light source as compared to the second ultraviolet light source.

8. The system of claim 1, wherein the wet chemicals that the wet processing module is configured to apply comprises at least one or more of: dilute hydrogen peroxide solution, deionized water, dilute hydrogen fluoride solution, semi-aqueous solvent mixture, dilute ammonium hydroxide mixture, and dilute carbonic acid.

9. The system of claim 1, wherein the substrate transfer mechanism is configured to control scan speed of the semiconductor substrate under the first ultraviolet light source and under the second ultraviolet light source.

10. The system of claim 1, wherein the light module further comprises a third ultraviolet light source that provides light at a third wavelength when the third ultraviolet light source is activated, the third wavelength being greater than the second wavelength.

11. The system of claim 10, wherein the first wavelength and the second wavelength comprise a wavelength that is less than 240 nanometers, and wherein the third wavelength comprises a wavelength that is greater than 240 nm.

12. The system of claim 11, wherein the first wavelength comprises a wavelength between 185 nanometers and 195 nanometers, and wherein the second wavelength comprises a wavelength that is greater than the first wavelength and that is less than the third wavelength.

13. The system of claim 12, wherein the first wavelength comprises a wavelength of 190 nanometers.

14. The system of claim 13, wherein the second wavelength comprises a wavelength of 230 nanometers.

15. The system of claim 14, wherein the third wavelength comprises a wavelength of 250 nanometers.

16. The system of claim 1, wherein the first ultraviolet light source is positioned adjacent to the second ultraviolet light source.

17. The system of claim 1, wherein the first ultraviolet light source and the second ultraviolet light source are positioned adjacent to each other and arranged approximately lengthwise to a path of the semiconductor substrate on the substrate transfer mechanism.

18. The system of claim 1, wherein the first ultraviolet light source and the second ultraviolet light source are positioned adjacent to each other and arranged approximately crosswise to a path of the semiconductor substrate on the substrate transfer mechanism.

19. A semiconductor substrate cleaning system comprising:
a wet processing module configured to apply wet chemicals to a semiconductor substrate; and
a light module configured to apply ultraviolet light to the semiconductor substrate, the light module comprising:
a first ultraviolet light source that provides light at a first wavelength when the first ultraviolet light source is activated, the first ultraviolet light source including a first excimer lamp;
a second ultraviolet light source that provides light at a second wavelength when the second ultraviolet light source is activated, the second ultraviolet light source including a second excimer lamp, the second wavelength being greater than the first wavelength; and
a substrate transfer mechanism configured to transfer the semiconductor substrate between the wet processing module and the light module.

20. The system of claim 19, wherein the first wavelength comprises a wavelength between 185 nanometers and 240 nanometers, and wherein the second wavelength comprises a wavelength between 240 nanometers and 270 nanometers.
